(19) United States
(12) Patent Application Publication
(10) Pub. No.: US 2008/0254926 A1
(43) Pub. Date: Oct. 16, 2008

(54) Traction Mechanism Drive

(75) Inventors: Bolko Schuseil, Adelsdorf (DE); Jin Kim, Gunpo-Si (KR)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/997,599

(22) PCT Filed: Jul. 27, 2006
(86) PCT No.: PCT/EP2006/007435

§ 371 Date: Jun. 26, 2008

(30) Foreign Application Priority Data
Aug. 2, 2005 (DE) 10 2005 036 206.0

(51) Int. Cl. F16H 7/08; F16H 7/18

(52) U.S. Cl. 474/111

(57) ABSTRACT

The invention relates to a traction mechanism drive, in particular a control drive of an internal combustion engine, comprising an endless traction mechanism which connects a drive wheel and at least one driven wheel in a form-fitting manner and on the circumference of which at least one pressure medium-actuated tensioning device and a guide rail (1) having a support body (4) and a sliding lining body (2) which is fastened to the support body (4) on the side of the traction mechanism are arranged.

To avoid inadmissible relaxation of the traction mechanism, in particular in the event of an engine start after a relatively long downtime, the guide rail (1) is configured so as to be adjustably movable at least partially normally with respect to the traction mechanism, is acted on with an adjusting force by at least one spring element (14) in the direction of the traction mechanism and is provided at least with an outer stop for delimiting an adjusting movement oriented away from the traction mechanism.

### FIELD OF THE INVENTION

The invention relates to a traction mechanism drive, in particular a control drive of an internal combustion engine, comprising an endless traction mechanism which connects a drive wheel and at least one driven wheel in a form-fitting manner and on the circumference of which at least one pressure medium-actuated tensioning device and a guide rail having a support body and a sliding lining body which is fastened to the support body on the side of the traction mechanism are arranged.

### BACKGROUND OF THE INVENTION

Traction mechanism drives with form-fitting power transmission can be configured as a chain drive with a link chain as the traction mechanism and with chain wheels as drive wheels, or as a synchronous belt drive with a synchronous belt as the traction mechanism and with belt gear-wheels as drive wheels. Traction mechanism drives of this type are used in internal combustion engines as a control drive for controlling the exchange of gases, at least one respective camshaft being driven by the crankshaft via the traction mechanism and the associated gas exchange valves, i.e. inlet and outlet valves, thus being opened and closed as a function of the angle of rotation of the crankshaft.

If there is a relatively large distance between the crankshaft wheel, which acts as the drive wheel, and the camshaft wheel, which acts as the driven wheel, a guide rail is preferably arranged on the load strand of the traction mechanism and a tensioning device is preferably arranged on the slack strand of the traction mechanism. The guide rail, which usually consists of an elongate support body, which is made of a light metal alloy or a fibre-reinforced plastics material, is arranged laterally parallel to the load strand and is mounted so as to be secured to the housing, and of a sliding lining body, which is made of a low-friction and wear-proof plastics material and is fastened to the support body on the side of the traction mechanism, serves substantially to suppress radial impact and vibrational movements of the traction mechanism and thus to avoid large dynamic loads and high noise formation of the traction mechanism drive.

The tensioning device, which in many cases has a spring and pressure medium-loaded tensioning element which is in contact with the traction mechanism, such as a tensioning rail or a tensioning roller, is used to compensate for dynamic and static changes in length of the traction mechanism and to ensure form-fitting connection of the drive wheels at the correct angle of rotation by the traction mechanism, and thus to prevent adjustment of the valve control times and damage to the valve and piston drives.

A typical control drive of an internal combustion engine is described, for example, in DE 203 04 345 U1. This known control drive has a drive wheel, which is securely connected to the crankshaft of the internal combustion engine, and two driven wheels which are each rigidly connected to one of two upper camshafts, wrapped round by an endless traction mechanism and joined together in a form-fitting manner. A guide rail, which consists of a support body which is rigidly mounted on the housing of the internal combustion engine and a sliding lining body which is fastened to the support body on the side of the traction mechanism, is arranged on the load strand of the traction mechanism. The sliding lining body can be riveted, screwed, bonded or, as is known for example from DE 103 33 077 A1, clipped onto the support body, i.e. locked in a form-fitting manner.

A tensioning device, which consists of a tensioning rail and a tensioning unit, is arranged on the slack strand of the traction mechanism. The tensioning rail is similar in its construction to the guide rail and comprises a traction body and a sliding lining body which is fastened to the support body on the side of the traction mechanism. At its leading end, toward which the traction mechanism moves during operation, the support body has a cylindrical bore and is thus attached to a bearing bolt which is secured to the housing and about which the tensioning rail is pivotably mounted. In the region of the trailing end, away from which the traction mechanism moves during operation, the support body of the tensioning rail is acted on with a tensioning force by the tensioning piston of a hydraulically acting tensioning unit, on its back which is remote from the traction mechanism, set apart from the bearing bolt.

A similar control drive of an internal combustion engine is known from DE 102 47 419 A1. In contrast to the above-described control drive, this tensioning device comprises a tensioning lever which is connected to the traction mechanism via a rotatable tensioning roller and is pivotably mounted, at its trailing end comprising a cylindrical bore, on a bearing bolt which is secured to the housing and is acted on, at its leading end, with a tensioning force by the tensioning piston of a hydraulically acting tensioning unit, on its back which is remote from the traction mechanism.

In both known embodiments, the tensioning unit is respectively connected to the oil circuit of the internal combustion engine, so the hydraulic tensioning force rises substantially proportionally to the rotational speed of the internal combustion engine. However, the adjustment distance of the tensioning piston is restricted owing to its design, so accordingly only limited elongation of the traction mechanism can be compensated for by the tensioning device.

A check valve, which prevents rapid emptying of the pressure chamber and thus rapid engagement of the tensioning piston with the pressure chamber once the internal combustion engine has been switched off, is arranged in the line for feeding the pressure medium into the pressure chamber of the tensioning unit. A compression spring, which is conventionally arranged inside the pressure chamber and acts on the tensioning piston, can also prevent in the pressureless state complete engagement of the tensioning piston with the pressure chamber and thus ensure minimum tensioning of the traction mechanism.

However, in the event of an engine start after a relatively long downtime, a movement, caused by the traction mechanism, of engagement of the tensioning piston with the pressure chamber, which movement can, especially in the event of relatively marked elongation of the traction mechanism, be so great that the traction mechanism is no longer sufficiently tensioned and the toothed traction mechanism skips on one of the drive wheels, can occur until a sufficiently high oil pressure has built up. Even form-fitting staggered steps between the tensioning piston and the piston guide of the tensioning unit cannot reliably prevent this and are, in addition, complex in their construction and expensive to produce.

### OBJECT OF THE INVENTION

The invention is therefore based on the object of developing the traction mechanism drive of the type mentioned at the outset in such a way as to prevent as simply and cost-effectively as possible inadmissible relaxation of the traction mechanism, in particular in the event of an engine start after a relatively long downtime.

### SUMMARY OF THE INVENTION

The invention is based on the finding that inadmissible relaxation of the traction mechanism and at least temporary cancellation associated therewith of the form-fitting connection between the traction mechanism and the drive wheels can be prevented as a result of the fact that the guide rail is mounted or configured so as to be movable normally with respect to the traction mechanism and is pressed, starting from an outer stop, against the traction mechanism via a spring element.

According to the features of claim 1, the invention therefore relates to a traction mechanism drive, in particular a control drive of an internal combustion engine, comprising an endless traction mechanism which connects a drive wheel and at least one driven wheel in a form-fitting manner and on the circumference of which at least one pressure medium-actuated tensioning device and a guide rail having a support body and a sliding lining body which is fastened to the support body on the side of the traction mechanism are arranged. In addition, provision is made, in the case of this traction mechanism drive, for the guide rail to be configured so as to be adjustably movable at least partially normally with respect to the traction mechanism, to be acted on with an adjusting force by at least one spring element in the direction of the traction mechanism and to be provided at least with an outer stop for delimiting an adjusting movement oriented away from the traction mechanism.

The term “normally” refers in the present document in a manner conventional per se to an orientation perpendicular to the surface of an associated component.

Advantageous configurations of the traction mechanism drive according to the invention, which will be described hereinafter in greater detail, are disclosed in Claims 2 to 10.

In normal operation, i.e. when the traction mechanism is sufficiently tensioned by the tensioning device, the guide rail is pressed by the tensioned traction mechanism, counter to the restoring force of the spring element, up to the outer stop and has then the same function as a rigid guide rail. If, however, the traction mechanism is on the other hand substantially relaxed, such as is the case, for example, during an engine start after a relatively long downtime, the guide rail is displaced or pivoted with the sliding lining body by the spring element, fully or partially automatically depending on the design, toward the traction mechanism, so the traction mechanism is tensioned and skipping of the traction mechanism on one of the drive wheels is prevented.

As soon as the tensioning device has been filled with sufficient pressurized oil and is thus fully operative again, the guide rail is pressed back into the starting position, i.e. against the outer stop, by the traction mechanism which is in this case substantially tensioned via the tensioning device. The configuration according to the invention of the traction mechanism drive thus increases the operational reliability thereof in a relatively simple and cost-effective manner.

Although DE 198 56 705 A1 proposes providing the guide and tensioning rails of a traction mechanism drive with resilient regions, for example in that the respective support bodies are configured in the region of their fastening and bearing points as mass-loaded spring clips or spring tongues, this configuration of the support bodies serves only to damp relatively high-frequency vibrational movements of the traction mechanism at relatively small amplitudes and thus to reduce the noise formation of the traction mechanism drive. Support bodies configured in this way are, however, unsuitable for achieving relatively large adjustment distances with which compensation for the length of the traction mechanism could be brought about.

The movability of the guide rail according to the invention can be achieved in that the support body is mounted in the region of a longitudinal-side end comprising a cylindrical bearing bore so as to be pivotable about an axis-parallel bearing bolt secured to the housing, is displaceably guided in the region of the opposite longitudinal-side end with a slot-like guide opening, which is oriented substantially normally with respect to the traction mechanism, on an axis-parallel guide bolt secured to the housing, and is loaded by the spring element set apart from the bearing bolt. The pivoting movement of the guide rail is, in this case, delimited in both directions by the stop of the guide bolt at the respective end of the closed guide opening.

For the sake of clarity, it should be noted that the longitudinal extension of the slot-like guide opening points in the direction of the traction mechanism.

To avoid an erecting moment caused by the friction between the traction mechanism and the sliding lining body, the bearing bore is expediently arranged on the support body in the region of the leading end of the guide rail, toward which the traction mechanism moves during operation, and the guide opening is arranged on the support body in the region of the trailing end of the guide rail, away from which the traction mechanism moves during operation.

The spring element can in this case be configured as a compression spring, for example in the form of a helical spring, which is arranged inside or else outside the guide opening between the guide bolt and the traction mechanism-side inner end of the guide opening.

Alternatively or additionally thereto, use may also be made of a spring element which is configured as a leg spring which is coaxially arranged on the bearing bolt and one leg of which is supported on the side of the housing and the other leg of which is supported on the support body.

It is also possible for use to be made of a spring element which is configured as a leaf spring, is arranged on the back, remote from the traction mechanism, of the support body, is supported at its end on the side of the housing and centrally abuts the back of the support body.

Alternatively or additionally to the above-described configurations of the guide rail, a spring element can also be arranged between the sliding lining body and the support body. This achieves movability of the sliding lining body relative to the support body and normally with respect to the traction mechanism, which movability is delimited in the direction of the traction mechanism substantially by relaxation of the spring element and in the opposite direction by the inside of the support body or clamping of the spring element.

In this case, the sliding lining body is preferably flexible in its configuration, rigidly connected to the support body in the region of a longitudinal-side end and held in the region of the opposite longitudinal-side end so as to be tangentially displaceable on the support body. As a result, the sliding lining body is, on the one hand, reliably fastened to the support body and can, on the other hand, be optimally adapted to the respective adjustment distance relative to the support body.

To avoid an erecting moment caused by the friction between the traction mechanism and the sliding lining body, the sliding lining body is expediently rigidly connected to the support body in the region of the leading end of the guide rail and held in the region of the trailing end of the guide rail so as to be tangentially displaceable on the support body.

The spring element is in this case preferably configured as a leaf spring which is arranged between the back, remote from the traction mechanism, of the sliding lining body and the traction mechanism-side inside of the support body, is mounted at its end on the support body and centrally abuts the back of the sliding lining body. Furthermore, the invention includes integration of the spring element into the sliding lining.

Combination of a configuration of this type of the guide rail with one of the aforementioned embodiments can advantageously increase the adjustment distance and thus improve the emergency tensioning function.

### BRIEF DESCRIPTION OF THE DRAWINGS

The invention will be described hereinafter in greater detail based on certain embodiments and with reference to the appended drawings, in which:

FIG. 1 is a side view of a first embodiment of a guide rail;

FIG. 2 is a side view of a second embodiment of a guide rail;

FIG. 3 is a side view of a third embodiment of a guide rail; and

FIG. 4 is a side view of a fourth embodiment of a guide rail.

### DETAILED DESCRIPTION OF THE DRAWINGS

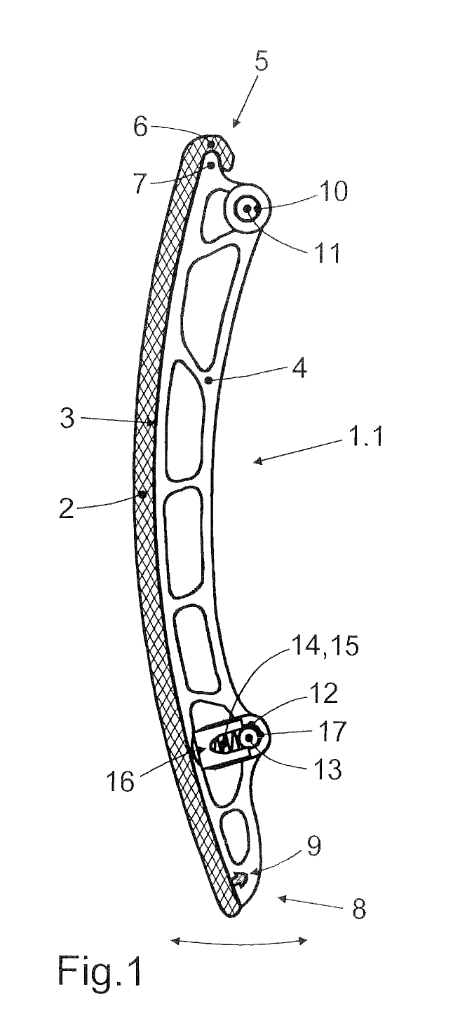

In a first embodiment of a guide rail 1.1 of the traction mechanism drive according to the invention as shown in FIG. 1, a sliding lining body 2 is rigidly fastened on the inside 3, facing a traction mechanism such as a link chain or an asynchronous belt, of a traction body 4. For this purpose, the sliding lining body 2 comprises at one longitudinal-side end, which is preferably the leading end 5 of the guide rail 1.1, toward which the traction mechanism moves during operation, with a hook end 6 a rib end 7 of the support body 4 and is connected in the region of the opposite end, which is preferably the trailing end 8 of the guide rail 1.1, away from which the traction mechanism moves during operation, to the support body 4 via a lock 9.

The support body 4 is mounted in the region of the leading end 5 comprising a cylindrical bearing bore 10 so as to be pivotable about an axis-parallel bearing bolt 11 which is secured to the housing. In the region of the trailing end 8, the support body 4, which comprises a slot-like guide opening 12 which is oriented substantially normally with respect to the traction mechanism, is displaceably guided on an axis-parallel guide bolt 13 which is secured to the housing. A spring element 14, in the form of a compression spring 15 configured as a helical spring between the traction mechanism-side inner end 16 of the guide opening 12 and the guide bolt 13, is arranged inside the guide opening 12.

As a result, when the traction mechanism is relaxed as illustrated in FIG. 1, the guide rail 1.1 is pivoted by the compression spring 15 about the bearing bolt 11 in the direction of the traction mechanism, at most up to the stop of the outer end 17, remote from the traction mechanism, of the guide opening 12 on the guide bolt 13, thus tensioning the traction mechanism.

When the traction mechanism is loaded, the guide rail 1.1 is, on the other hand, pivoted by the traction mechanism, which is tensioned by a pressure medium-actuated tensioning device, about the bearing bolt 11 away from the traction mechanism, counter to the restoring force of the compression spring 15, up to the stop of the traction mechanism-side inner end 16 of the guide opening 12 on the guide bolt 13 or up to the compression spring 15, which is almost blocked, and this corresponds to the normal position in the case of a traction mechanism drive in operation.

The configuration according to the invention of the guide rail 1.1 can therefore prevent inadmissible relaxation of the traction mechanism, for example in the case of a control drive of an internal combustion engine, in particular, during an engine start after a comparatively long downtime, in a relatively simple and cost-effective manner.

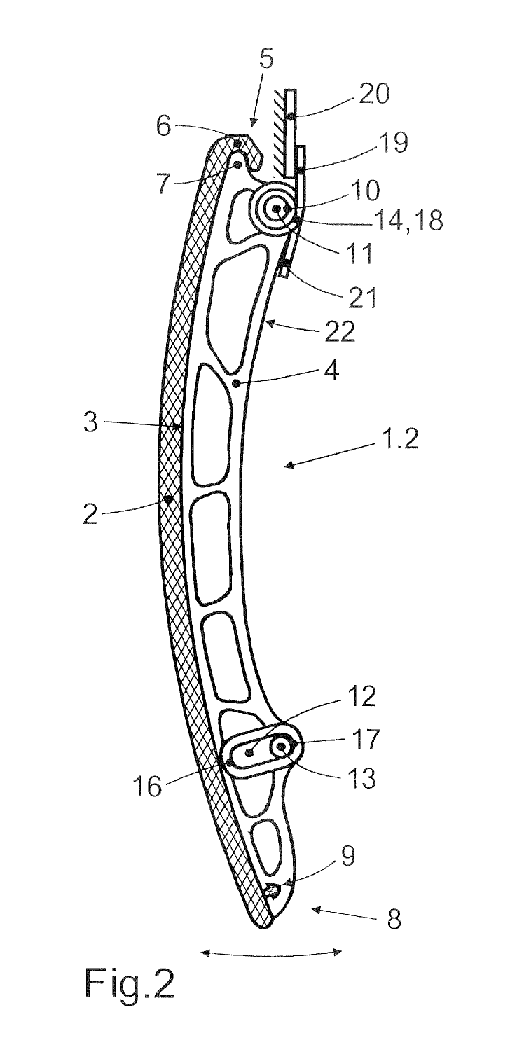

In a second embodiment of a guide rail 1.2 of the traction mechanism drive according to the invention as shown in FIG. 2, in contrast to the above-described embodiment, the spring element 14 is in this case configured as a leg spring 18 which is arranged coaxially on the bearing bolt 11 and the one leg 19 of which is supported on the side of the housing, for example on a housing rib 20, and the other leg 21 of which is supported on the support body 4, in FIG. 2, by way of example, on the back 22 thereof remote from the traction mechanism, the construction otherwise being the same.

As was performed by the compression spring 14 in the above-described embodiment, the guide rail 1.2 is in this case pivoted, when the traction mechanism is relaxed, by the leg spring 18 about the bearing bolt 11 in the direction of the traction mechanism, at most up to the stop of the outer end 17 of the guide opening 12 on the guide bolt 13, thus tensioning the traction mechanism. Similarly, when the traction mechanism is loaded, the guide rail 1.2 is pivoted by the traction mechanism about the bearing bolt 11 away into the normal position by the traction mechanism, counter to the restoring force of the leg spring 18, up to the stop of the inner end 16 of the guide opening 12 on the guide bolt 13.

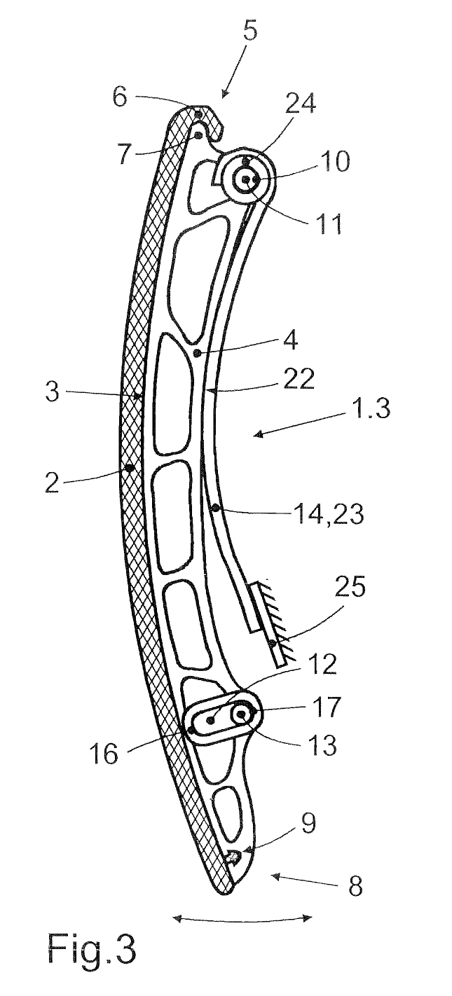

In a third variation of a guide rail 1.3 of the traction mechanism drive according to the invention as shown in FIG. 3, the spring element 14 is configured, in contrast to the above-described embodiments, as a leaf spring 23 which is arranged on the back 22, pointing away from the traction mechanism, of the support body 4, is supported at its end on the side of the housing, in FIG. 3, by way of example, on a bearing sleeve 24, surrounding the bearing bolt 11, of the support body 4 and on a housing rib 25, and centrally abuts the back 22 of the support body 4, the construction otherwise being the same.

As in the above-described embodiments, the guide rail 1.2 is in this case pivoted, when the traction mechanism is relaxed, by the leaf spring 23 about the bearing bolt 11 in the direction of the traction mechanism, at most up to the stop of the outer end 17 of the guide opening 12 on the guide bolt 13, thus tensioning the traction mechanism, and is pivoted, when the traction mechanism is loaded, away from the traction mechanism into the normal position, counter to the restoring force of the leaf spring 23, up to the stop of the inner end 16 of the guide opening 12 on the guide bolt 13.

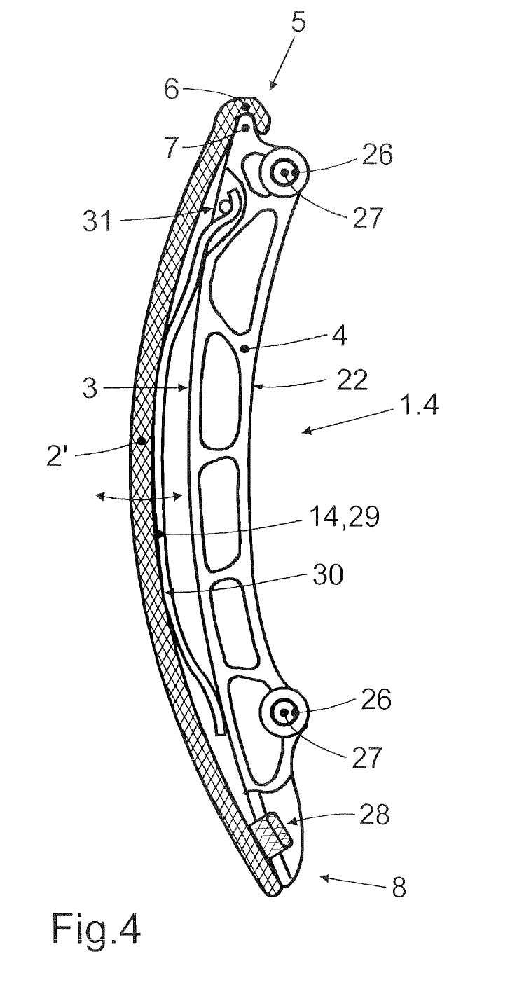

In a fourth embodiment of a guide rail 1.4 of the traction mechanism drive according to the invention as shown in FIG. 4, the support body 4 is, on the other hand, fastened rigidly, i.e. immovably, to a housing part via two cylindrical fastening bores 26 and two fastening bolts 27 which are secured to the housing. The sliding lining body 2′ is in this case flexible in its configuration and fastened to the inside 3, facing the traction mechanism, of the support body 2 in that said sliding lining body is held at one longitudinal-side end, preferably the leading end 5 of the guide rail 1.4, with a hook end 6 on a rib end 7 of the support body 4 and in the region of the opposite end, preferably the trailing end 8 of the guide rail 1.4, so as to be tangentially displaceable on the support body 4 by means of a locking guide 28.

A spring element 14 which is configured as a leaf spring 29 is arranged between the back 30, facing the traction mechanism, of the sliding lining body 2′ and the traction mechanism-side inside 3 of the support body 4, mounted at its end on the support body 4, in FIG. 4, by way of example, on an axis-parallel bearing bolt 31 and on the inside 3, and centrally abuts the back 30 of the sliding lining body 2′.

When the traction mechanism is relaxed, the sliding lining body 2′ is pressed by the leaf spring 29 in the direction of the traction mechanism, at most until said leaf spring is relaxed away from the inside 3 of the support body 4, with tangential displacement on the locking guide 28, thus tensioning the traction mechanism. When the traction mechanism is loaded, the sliding lining body 2′ is, on the other hand, pressed back by the traction mechanism, which is tensioned by a pressure medium-actuated tensioning device, counter to the restoring force of the leaf spring 29, until said tensioning device abuts the inside 3 of the support body 4, corresponding to the normal position during normal operation of the traction mechanism drive. This configuration of the guide rail 1.4 can also prevent inadmissible relaxation of the traction mechanism in a simple and cost-effective manner.

The proposed variations or embodiments of the guide rail 1.1 to 1.4 according to the invention can also be combined with one another.

### LIST OF REFERENCE NUMERALS

1 Guide rail
1.1 Guide rail
1.2 Guide rail
1.3 Guide rail
1.4 Guide rail
2 Sliding lining body
2′ Sliding lining body
3 Inside of the support body
4 Support body
5 Leading end
6 Hook end
7 Rib end
8 Trailing end
9 Lock
10 Bearing bore
11 Bearing bolt
12 Guide opening
13 Guide bolt
14 Spring element
15 Compression spring
16 Inner end of the guide opening
17 Outer end of the guide opening
18 Leg spring
19 Leg
20 Housing rib
21 Leg
22 Back of the support body
23 Leaf spring
24 Bearing sleeve
25 Housing rib
26 Fastening bore
27 Fastening bolt
28 Locking guide
29 Leaf spring
30 Back of the sliding lining body
31 Bearing bolt

1. Traction mechanism drive of an internal combustion engine, comprising an endless traction mechanism which connects a drive wheel and at least one driven wheel in a formfitting manner and on the circumference of which at least one pressure medium-actuated tensioning device and a guide rail having a support body and a sliding lining body which is fastened to the support body on the side of the traction mechanism are arranged, wherein the guide rail is configured so as to be adjustably movable at least partially normally with respect to the traction mechanism, is acted on with an adjusting force by at least one spring element in the direction of the traction mechanism and is provided at least with an outer stop for delimiting an adjusting movement oriented away from the traction mechanism.

2. Traction mechanism drive according to claim 1, wherein the support body is mounted in the region of a longitudinal-side end comprising a cylindrical bearing bore so as to be pivotable about an axis-parallel bearing bolt secured to the housing, is displaceably guided in the region of the opposite longitudinal-side end with a slot-like guide opening, which is oriented substantially normally with respect to the traction mechanism, on an axis-parallel guide bolt secured to the housing, and is loaded by the spring element set apart from the bearing bolt.

3. Traction mechanism drive according to claim 2, wherein the bearing bore is arranged on the support body in the region of the leading end of the guide rail and the guide opening is arranged on the support body in the region of the trailing end of the guide rail.

4. Traction mechanism drive according to claim 2 wherein the spring element is configured as a compression spring which is arranged inside the guide opening between the guide bolt and the traction mechanism-side inner end of the guide opening.

5. Traction mechanism drive according to claim 2, wherein the spring element is configured as a leg spring which is coaxially arranged on the bearing bolt and one leg of which is supported on the side of the housing and the other leg of which is supported on the support body.

6. Traction mechanism drive according to claim 2, wherein the spring element is configured as a leaf spring which is arranged on the back, remote from the traction mechanism, of the support body, is supported at its end on the side of the housing and centrally abuts the back of the support body.

7. Traction mechanism drive according to claim 2, wherein the spring element is arranged between the sliding lining body and the support body.

8. Traction mechanism drive according to claim 7, wherein the sliding lining body is flexible in its configuration, is rigidly connected to the support body in the region of a longitudinal-side end and is held in the region of the opposite longitudinal-side end so as to be tangentially displaceable on the support body.

9. Traction mechanism drive according to claim 8, wherein the sliding lining body is rigidly connected to the support body in the region of the leading end of the guide rail and held in the region of the trailing end of the guide rail so as to be tangentially displaceable on the support body.

10. Traction mechanism drive according to claim 8, wherein the spring element is configured as a leaf spring which is arranged between the back, remote from the traction mechanism, of the sliding lining body and the traction mechanism-side inside of the support body, is mounted at its end on the support body and centrally abuts the back of the sliding lining body.
